(19) United States
(12) Patent Application Publication
(10) Pub. No.: US 2008/0034756 A1
(43) Pub. Date: Feb. 14, 2008

(54) Air Compression Heat Accumulating Power Plant With An Underground Heat Accumulator Formed In The Aquifer (Gaes)

(76) Inventor: Egils Spalte, Rigas raj (LV)

Correspondence Address: NOTARO AND MICHALOS, 100 DUTCH HILL ROAD, SUITE 110, ORANGEBURG, NY, 10962-2100, US

(21) Appl. No.: 11/579,290

(22) PCT Filed: Mar. 30, 2005
(86) PCT No.: PCT/LV05/00003

§ 371 Date: Nov. 2, 2006

(30) Foreign Application Priority Data
May 8, 2004 (LV) P-04-55

(51) Int. Cl. F02C 6/18; F02C 7/12

(52) U.S. Cl. 60/641.3

(57) ABSTRACT

The offered high-temperature GAES is designed as a stabilising structure in high-power electroenergetic systems to ensure high quality, economy and safety of these systems. The GAES relates to electric energy accumulation equipment in which the unclaimed electric energy is converted by means of an electrically-driven compressor (3, 4, 6) into the air compression heat working medium-air (WMA) and WMA pressure potential energies accumulated in Underground Heat Accumulator (UHA) (14) and, in case of the demand, these potential energies from UHA (14) by means of the WMA turbine (18, 19) and the turbogenerator (21), converted back into electric energy. The principal novelty of the proposed GAES is that UHA (14) is formed in the aquifer (15) which, at the same time, is the storage of the compressed WMA. UHA (14) is conditioned to the WMA pressure (volume), temperature, moisture ensuring agreement of these parameters with certain parameters of the UHA (14) operation. A thermos-type pressure duct (13) has developed for the transfer of the WMA into/out of UHA (14). A rock cementation method has been worked out. The GAES can be formed on the aquifer (15) base at the depth from 150 to 700 m. The GAES ensures practically unlimited energy capacity and a high coefficient of efficiency of about 85%.

### DESCRIPTION OF INVENTION

According to the International Patent Classification (IPC), this invention relates to Classes F02C6/14; F02C6/16.

The present invention concerns air compression heat accumulating power plant with an underground heat accumulator formed in the aquifer (GAES) (further—GAES) and is designed as a stabilising element in high-power electroenergetic systems in order to ensure high-quality functioning of these systems, their economy and safety.

The practically unlimited energy capacity of the GAES, the high coefficient of efficiency (further—CE) of approximately 85%, and the high dynamic properties of the GAES ensure:
A possibility to equalise completely the day-and-night and weekly schedule of electricity consumption in contemporary electroenergetic systems, which is ensured by accumulating the unclaimed night electric energy during the night failure of capacity and the days off, when this accumulated energy ensures the coverage of the peak hours and participation in the daily regulation mode.
A possibility to use more efficiently the main and cheap generating capacities—atomic power plants (further—APP) and thermal power plants (further—TPP). By ensuring the operation of the APP and TPP in a strictly nominal mode without any is manoeuvring with these capacities it possible to raise the efficient capacity of the APP and TPP approximately 1.3 times. In the case of the APP safety is increased significantly at the same time.
A possibility to refuse to use expensive gas turbines (further—GT) as the manoeuvring capacities. At the same time more efficient dynamic properties of the GAES in comparison with the GT ensure also higher standards of the quality of the electric energy (voltage, frequency, etc.).
A possibility to use highly efficiently alternative sources of energy (solar photo, wind, wave energy, etc.) ensuring the accumulation of the electric energy from other sources in any amount, any time, including the night failure of capacity, and in a wide range of quality of this electric energy. The GAES provides a possibility to create principally new schemes of using alternative sources of energy ensuring a higher CE and enabling the application of these sources of energy on a wider scale, such as the power of wind.

The deficit of the accumulating capacities in contemporary electric energy systems is immense. This issue is particularly urgent today when “the era of natural gas” used in energetics remains in the past. In the future the main generating capasities will be the APP and TPP operating on coal and the alternative sources of energy listed above.

In the new situation, due to expensiveness of the gas and other GT fuels, a problem arises of the use of the GT even in the manoeuvring mode, which raises substantially the cost of electric energy.

The GAES is designed for the power of 100 MW, and more, at the energy capacities of 500 MW·h, and more.

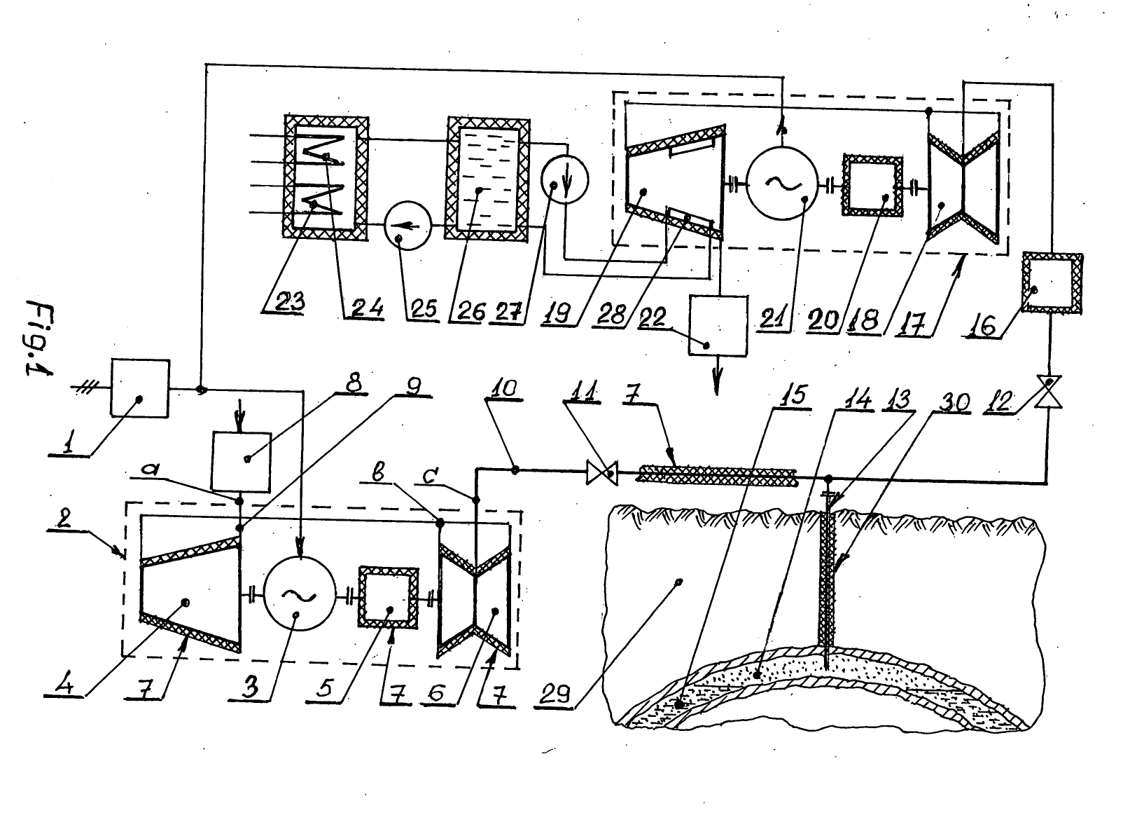

The GAES relates to the electric energy accumulating equipment in which the unclaimed electric energy is converted by means of an electrically-driven adiabatic compressor into the potential energies of the of the compression heat and pressure of the working medium-air (further—WMA) accumulated (the WMA heat energy) and stored (the compressed WMA) in the underground heat accumulator (or separate underground cavities) when these potential energies, in case of necessity, are converted back by means of an adiabatic WMA turbine and a turbogenerator into electric energy; and such a well-known equipment consists of the following functional blocks;
Compressor Block 2 (FIG. 1) equipped with compressor 4, 6 of the working medium air (WMA), electric motor 3 and WMA filter 8. Compressor 4, 6 may have a multiple-unit or a multi-sectional embodiment with an external intersectional cooling of WMA by means of the intersectional heat exchanger as well as with internal WMA cooling. By means of Compressor Block 2 the unclaimed electric energy from the external electroenergetic system is converted into the WMA compression heat and WMA pressure potential energies;
It can contain Heat Accumulator designed for the accumulation of the WMA external intersectional or internal cooling heat in case compressor 4, 6 equipped with an external intersectional or internal cooling system when the liquid of the intersectional or internal cooling system of compressor 4, 6 as a heat carrier substance is used in Heat Accumulator is used;
Underground Heat Accumulator in which the WMA compression heat and WMA pressure potential energies coming from the final unit or the final section of compressor 4, 6 are accumulated. The Underground Heat Accumulator is formed in a natural or artificially created reservoir of dense hard rock (whinstone) which is simultaneously a compressed WMA storage. In another embodiment the WMA compression heat is accumulated in the reservoir of the abovementioned hard rock (whinstone) which is filled with a heat accumulating substance (crushed stone, ceramics, and others) when the compressed WMA is stored in a separate underground reservoir which is formed after the aforementioned heat accumulator. Underground Heat Accumulator operates in a sliding pressure and temperature mode or, in a constant pressure mode if Underground Heat Accumulator is equipped with an upper water basin;
Turbine Block 17 equipped with the WMA turbine 18, 19, turbogenerator 21 and noise damper 22. Turbine 18, 19 may be in a multiple-unit or a multi-sectional embodiment with an external intersectional heating of WMA by means of the intersectional heat exchanger, as well as with internal WMA heating when this heat for heating is taken from Heat Accumulator designed for the accumulation of the WMA external intersectional or internal cooling heat in case compressor 4, 6 equipped with an external intersectional or internal cooling system. By means of Turbine Block 17 the WMA compression heat and WMA pressure potential energies from Underground Heat Accumulator, as well as the potential heat energy from Heat Accumulator designed for the accumulation of the WMA external intersectional or internal cooling heat (if it is used) are converted into electric energy which is returned into the external electroenergetic system during the energy gap. In individual cases turbine 18, 19 may be equipped with a combustion chamber;
Electric motor 3 and turbogenerator 21 may have the embodiment of an electric motor-generator which is common for Compressor Block 2 and Turbine Block 17 when clutch attachments are installed between compressor 4, 6 and electric motor-generator, and electric motor-generator and turbine 18, 19;
In another embodiment, the WMA external intersectional cooling heat exchanger(s) or the internal WMA cooling system of compressor 4, 6, as well as the WMA external intersectional heating heat exchanger(s) or the internal WMA heating system of turbine 18, 19 are common. In this case the WMA current is directed by corresponding valves.

Such a known electric energy accumulating equipment is discussed in Patents DE 2939631, U.S. Pat. No. 4,403,477, WO 9601942, JP 1110779, JP 63208627, US 3677008, U.S. Pat. No. 4,147,204, U.S. Pat. No. 4,150,547, and the main shortcomings of this equipment are the following:
Underground Heat Accumulator is formed in a natural or artificially created reservoir of dense hard rock (whinstone) of a very limited small volume which limits accordingly the small energy capacity of such an equipment and does nor satisfy the need of the large electroenergetic systems for accumulating capacities;
There are high losses of the WMA heat because the high-temperature WMA contacts directly the external dense whinstone walls of these reservoirs, which are good heat conductors. The losses of heat affect directly the CE of such equipment.

The GAES is characterised by the fact that with an aim to increase energy capacity till practically unlimited energy capacity and efficiency coefficient of the GAES, Underground Heat Accumulator 14, which is simultaneously a compressed WMA storage, is formed in a vertically closed, porous aquiferous underground collector stratum (aquifer) 15 into/out of which the WMA is transferred by means of pressure duct(s) 13, when:
The WMA compression heat is accumulated in the grainy mass (sand, gravel, and other) of the porous rock of Underground Heat Accumulator 14 or in the mass (sandstone, limestone, and other) of the porous structure of Underground Heat Accumulator 14, which takes place in the WHA by moving in the porous rock of Underground Heat Accumulator 14 by way of convection when the WMA is transferred through the porous rock of Underground Heat Accumulator;
The compressed WMA is stored in the space among the grains (sand, gravel, and other) of the porous rock of Underground Heat Accumulator 14 or in the porous structures (sandstone, limestone, and other) of Underground Heat Accumulator 14;
Underground Heat Accumulator 14 is vertically closed from above with an air-roof covering of a clay layer or layers, and with other rocks; from below it is confined with a floor covering (crystalline foundation, and other rock); in individual cases the lower layers of aquifer 15 may be a floor covering; Underground Heat Accumulator 14 being separated from aquifer 15 by the WMA—water front 47 (FIG. 7);
Underground Heat Accumulator 14 is equipped with pressure duct(s) 13 through which the WMA is transferred into/out of Underground Heat Accumulator 14. The layout of pressure ducts (13) is dependent on the power of the energoblock or the total power of the GAES, as well as the geophysical parameters (thickness, rock porosity, permeability, and others) of Underground Heat Accumulator 14. Besides Underground Heat Accumulator 14 may be equipped with control, observation, pressure-relief drainage and other auxiliary function wells;
If the GAES consists of several individual energoblocks, then Underground Heat Accumulator 14, which is designed according to claim 1, may be common for all the energoblocks.

The huge natural volumes of these aquifers (1−2×10⁹, and more), as well as the high heat capacity, ensure a possibility to form Underground Heat Accumulator 14 of a practically unlimited energy capacity; at the same time the structure of Underground Heat Accumulator 14 is considerably simpler and safer (no reservoirs are necessary); much less are the losses of heat, which is ensured by the high thermal insulation of the rocks surrounding aquifer 15.

The present GAES can be constructed on the basis of the collector aquifer at the depth from 150 to 700 m. The embodiment of the said GAES depends on the depth of the aquifer and its piesometric (internal) pressure which determines the operating pressure of the GAES and hence embodiment of the compressor and the air turbine. By their operating pressure (i.e., the depth of the aquifer), the GAES may be classified into two groups:
the GAES created on the collector aquifer foundation, up to 400 m deep, and operating without intersection cooling of air, the compressor working medium being air (further—WMA), by transmitting all the air compression heat from the final compressor body into the UHA (if losses are ignored);
The GAES created on the collector aquifer foundation deeper than 400 m and operating with intersection WMA cooling, accumulation of the intersection cooling heat or removal from the cooling system, regeneration of the accumulated heat during the turbine cycle; a part of the WMA compression heat is transferred from the final compressor section into the UHA.

The aim of this invention is not the embodiment of the compressor or the turbine, therefore the embodiment of the said GAES is described in its simplest embodiment when the air compression heat is transferred from the final compressor body immediately into the UHA without WMA intersection cooling.

The main criteria that determine the embodiment of the compressor are its maximum allowed compressed air temperature, which cannot be higher than the melting temperature of the porous rock or its chief components of the UHA, as well as the engineering standards for heat resistance of materials attained in machine (steam turbines, etc.) building today in order to ensure lasting performance of the compressor and turbines (200-300 thousand hours, and more). As such a limit of the compressed air temperature today is regarded the temperature of 650-700° C. The melting temperature of the porous rock found in practice meets these requirements.

It is clear that in case the GAES is designed for the use collector of deeper aquifers with a higher piesometric pressure, the air compression temperature would be higher than the allowed maximum (650-700° C.) and the compressor should be in a multiple-section embodiment with the generally-known intersection cooling heat accumulation and regeneration. When the GAES operated with the WMA intersection cooling, intersection cooling heat accumulation and regeneration, we discuss only the WMA intersection cooling heat accumulation version when the heat accumulator is created in the underground aquifer. At the same time it should be noted that the compressor embodiment without intersection cooling, when the air compression heat is directly transferred from the final body of the compressor into the UHA, is the simplest and the most economical embodiment of the said GAES. Such an GAES, in its simplest embodiment, can be constructed on the collector aquifer foundation with a piesometric pressure reaching 4.2 Mpa.

We choose an energetic block with a 300 MW power for the presently described embodiment of the GAES from the following considerations:
it is a sufficient power to ensure high technical and economical indices of every energetic block depending on the value of its power;
simultaneously it is a sufficiently mobile power in order to align the launching and stopping characteristics of separate energetic blocks of the GAES with the daily uneven consumption schedule of the high-power electroenergetic system.

The GAES may consist of one or several such energetic blocks.

The GAES operation is illustrated by the following FIGs.:

FIG. 1—the block diagram of the GAES;

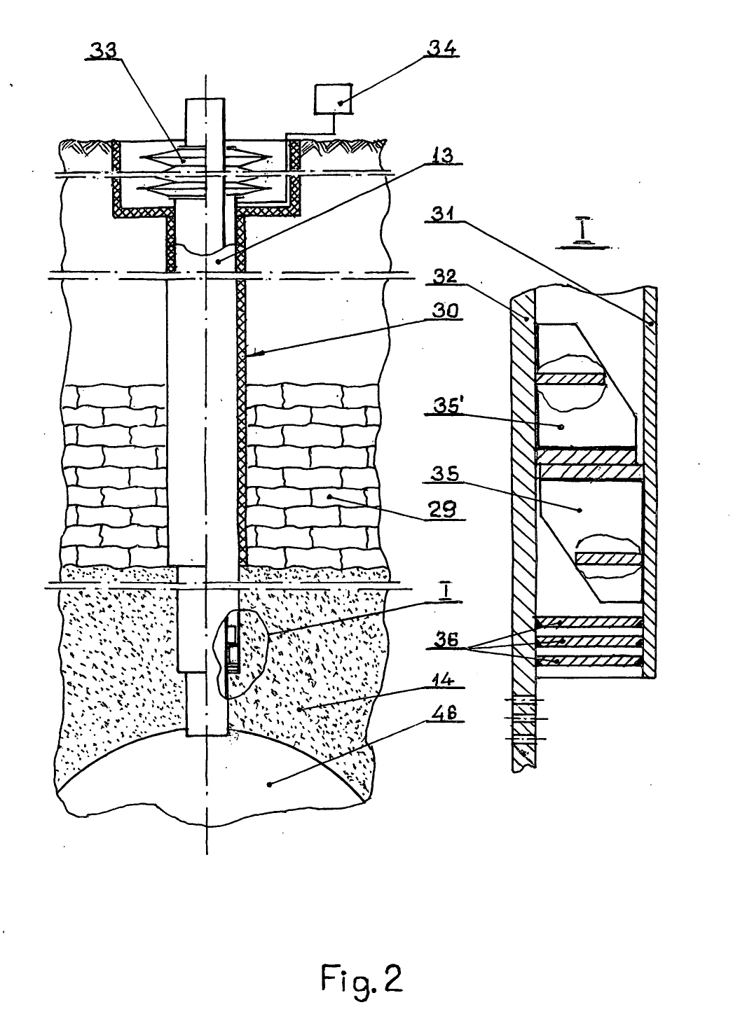

FIG. 2—the structure of the point type pressure duct of the GAES;

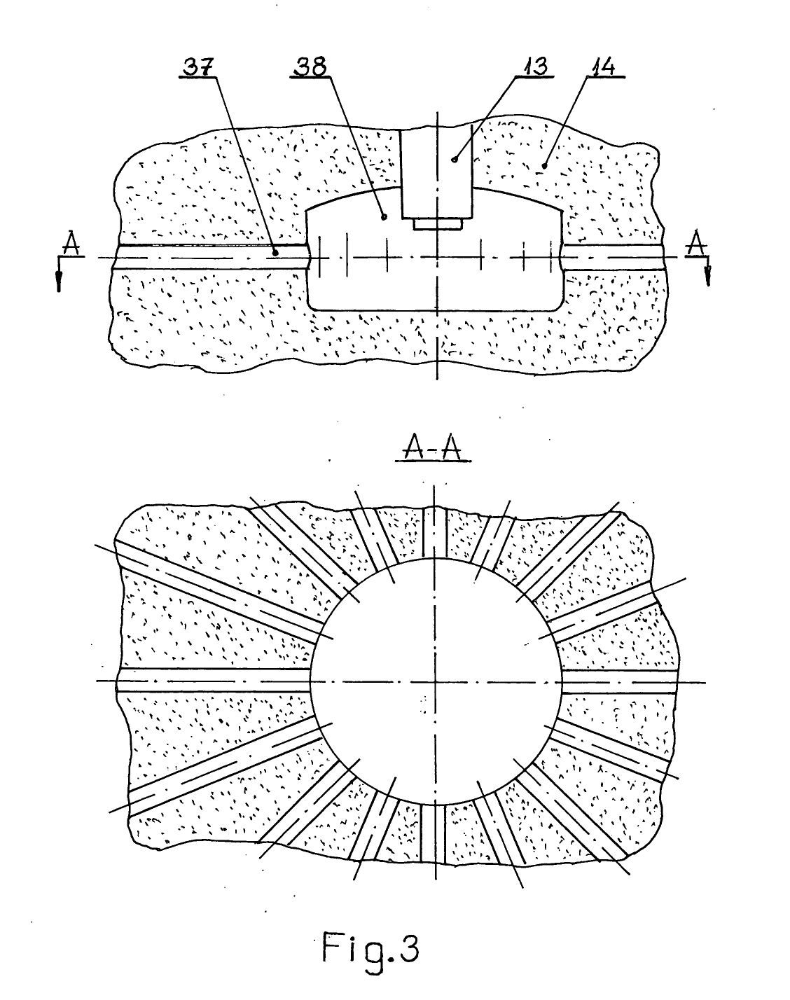

FIG. 3—the structure of the shaft-like pressure duct of the GAES;

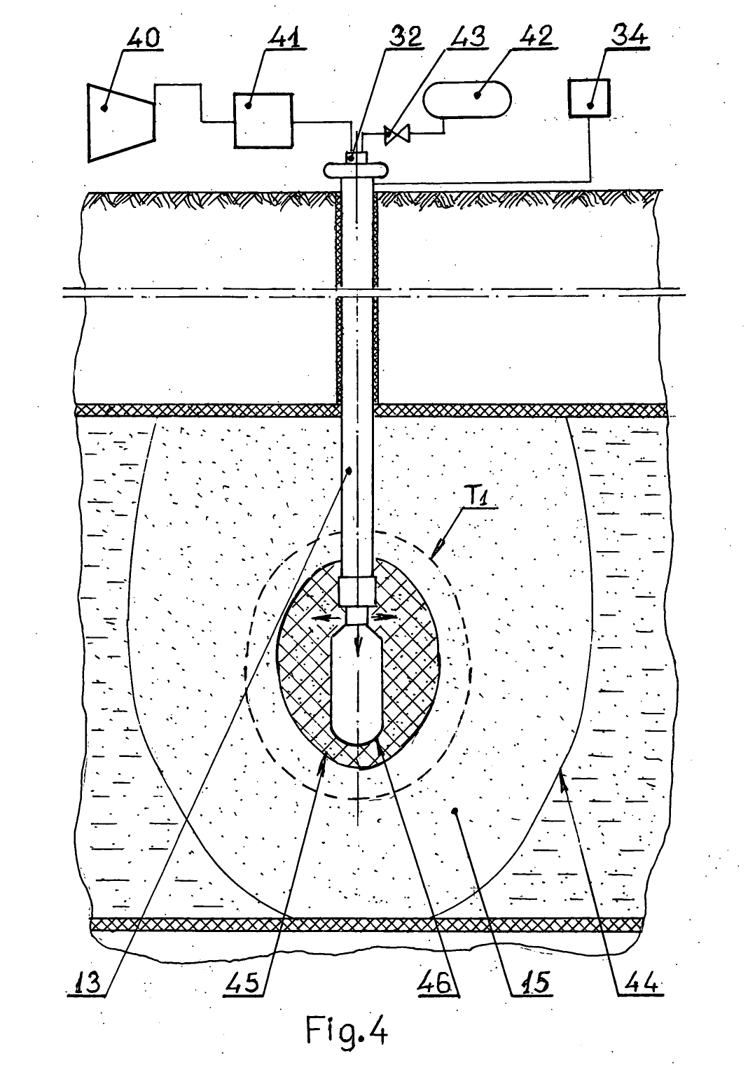

FIG. 4—the structure of the underground inlet of the point type pressure duct of the GAES and the method of its construction;

FIG. 5—the operating schedule of the GAES;

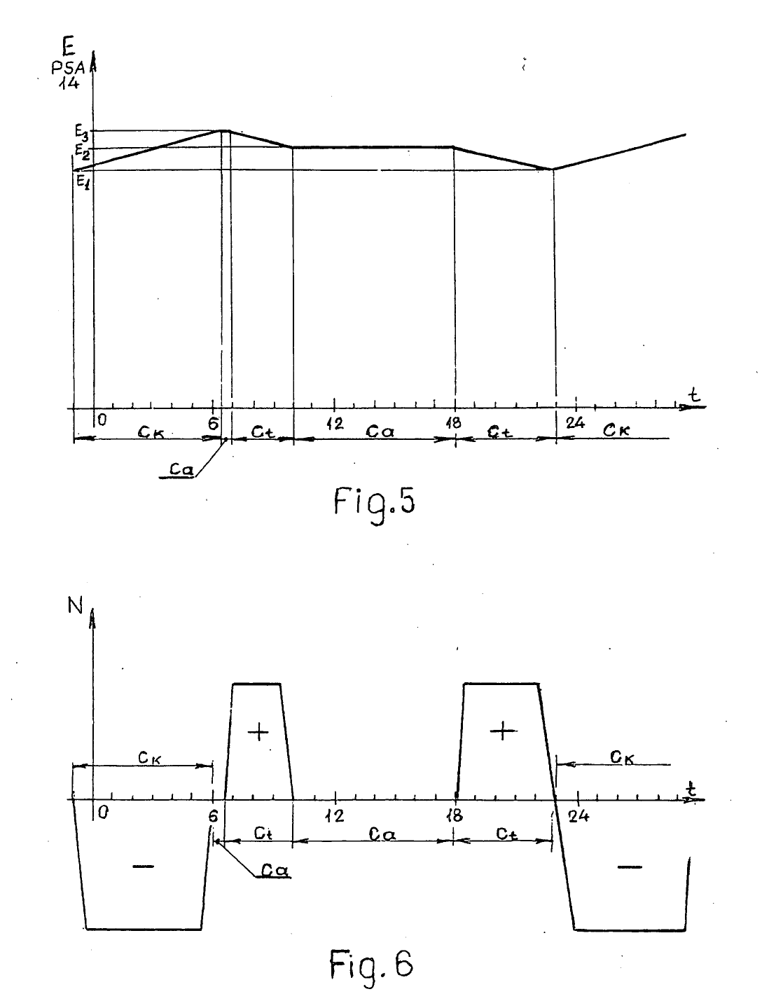

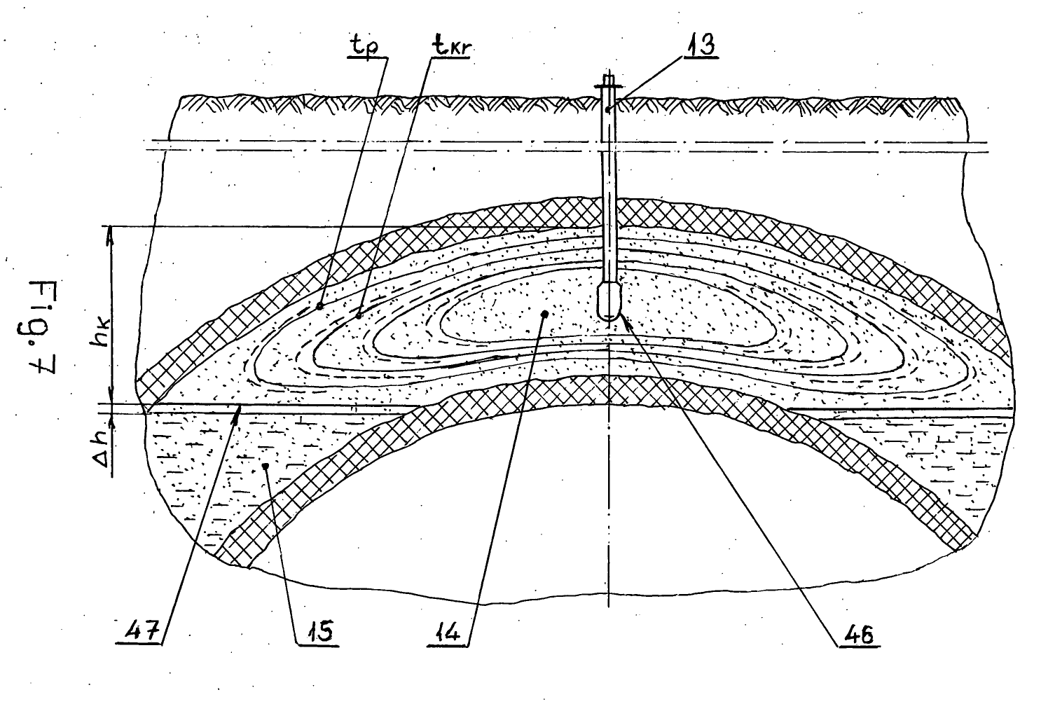

FIG. 6—the operating schedule of the compressors and turbine units;

FIG. 7—the operating diagram of the UHA.

The present GAES (FIG. 1) consists of the input-output transformer 1 which lowers voltage of the high-voltage network of the external electroenergetic system corresponding to the feeding voltage of the electric motor 3 of the compressor block 2. The electric motor 3 drives the axial low-pressure turbocompressor 4 and, through the multiplicator 5, the medium-pressure centrifugal turbocompressor 6. The number of revolutions 3000 rev./min of the electric motor 3 is increased by means of the multiplicator 5 from 8000 to 9000 rev./min, which is required to drive the centrifugal turbocompressor 6. Compressors 4 and 6, as well as the multiplicator 5, are enclosed in the heat-insulating casings 7 in the form of a profiled cushions ensuring simultaneously high sound insulation of compressors 4 and 6, and the multiplicator 5. The air is delivered into the compressor 4 from the atmosphere through the air filter 8 along the air duct 9. In the direct compressor cycle the WMA is conveyed from the outlet of the compressor 6 along the main air duct 10 through the valve 11 (the valve 12 is closed) and along the pressure ducts 13 in the collector aquifer (further pressure duct) into the underground heat accumulator (further—UHA) 14 formed in the aquifer 15.

FIG. 1 shows conditionally that the UHA 14 is formed in a cupola-shaped collector aquifer 15. Such a UHA 14 analogue can be also created in horizontal or slightly inclined aquifers.

In the reverse turbine cycle the WMA is delivered from the UHA 14 along the pressure ducts 13 and the main air duct 10 through the valve 11 (the valve 12 is closed) and, passing through the air purification unit 16, transferred to the turbine block 17 consisting of a medium-pressure air turbine 18, a low-pressure air turbine 19, a multiplicator 20 and a turbogenerator 21. The outgoing air is discharged from the turbine 19 into the atmosphere through the noise damper 22. The task of the multiplicator 20 is to align the 8000-9000 rev./min of the centripetal air turbine 18 with the 3000 rev./min of the turbogenerator 21.

Like in the case of the compressor block, the turbines 18 and 19, as well as the multiplicator 20, are enclosed in the heat-insulating casings 7.

Since the GAES operates as a stabilising factor in high-power electroenergetic systems, it has to guarantee high mobility of the compressor and turbine blocks 2 and 17, i.e., the compressor block 2 has to ensure at any time the reception, conversion and accumulation in the UHA 14 of the surplus electric energy of the system; and the turbine block 17, correspondingly, has to cover any deficit of the electric energy in the system at the expense of the energy stored in the UHA 14. Ensuring high mobility of the compressor and turbine blocks 2 and 17 is problematic due to the high temperature (650-700° C.) of the WMA and the related thermal expansion and, respectively, appearance of thermotensions in the compressor and turbine structures. In order to achieve high mobility, the compressor and the turbine are divided into two bodies, setting apart the medium-pressure bodies of the compressor and the turbine, which work within the range of the high temperatures, and transforming these bodies, correspondingly, into a medium-pressure centrifugal turbocompressor 6 and a medium-pressure centripetal turbine 18 having the following advantages in contrast to a case if these bodies were in an axial embodiment:
considerably less axial dimensions;
by providing additional labyrinth gland between the stator body and the turbine wheel it is possible to make the centrifugal compressor 6 and the centripetal air turbine 18 with very large axial gaps between the turbine wheel and the stator, which ensures their free operation within the entire temperature range;
the radial gaps between the turbine wheel and the diffuser, or the jet device, are not limiting and do not determine the operation mobility.

It is purposeful to make the compressor 6 and the turbine 18 in a two-flow embodiment with a common two-side turbine wheel. The maximum range of the working temperatures of the low-pressure compressor 4 and the turbine 19 does not exceed 300° C., and their axial embodiment ensures sufficient mobility from the point of view temperature variations.

If there were no requirements for high mobility, the compressor 6 and the turbine 18 would have to be unambiguously in an axial embodiment.

In order to avoid axial summation of thermal expansion, it is purposeful to place low-pressure units 4 and 19 and the medium-pressure units 6 and 18 on both sides of the electric motor 3 and turbogenerator 21.

If the GAES operates with intersection cooling of the compressor, accumulation and regeneration of the intersection cooling heat during the turbine cycle, then implementation of such a system is hardly possible due to the problems with the design of the intersection cooling heat accumulator. To provide a contour of heat regeneration in the air turbine by means of intersection heat exchange of the turbine (the cooling liquid—WMA), it is necessary to achieve that the working temperature of the heat accumulator is at least 250° C. It is problematic in view of the required energy capacity of the heat accumulator and, consequently, its great volume, which excludes the possibility to use water as a heat carrier since the use of water under pressure is practically excluded at such volumes.

Such GAES are offered which operate with a compressor intersection cooling heat accumulation and regeneration system, equipping them with a compressor intersection cooling heat underground heat accumulator(-s) created in a underground aquiferous collector stratum (strata). The main aquiferous collector stratum 15 can be employed as an aquifer in which the UHA 14 is created, or the upper layers of the aquifer if there are such. If there is multisection compressor cooling, then each section must have its own underground water heat accumulator. A water heat accumulator provided in the aquifer enables the use of water under a corresponding pressure of the heat carrier; considerable simplification of the structure since no big reservoirs are required with heat-resistant oils; significant raising of the CE of the heat accumulator thus raising the CE of the GAES because the heat losses of such water heat accumulators created in the aquifer are very small; raising the GAES safety for big reservoirs are not necessary with heated high-temperature oil.

The waters in the aquifers are more or less mineralised, which may cause salty sediments on the compressor or turbine intersection heat exchangers the WMA—aquiferous water. Therefore it is purposeful to use additional heat exchangers the aquiferous water—the heat carrier liquid, which cools or heats the respective compressor or turbine heat exchangers in the WMA tract. Distilled water under appropriate pressure or a heat resistant oil, etc. can be used as a heat carrier liquid thus protecting the expensive heat carrier liquid from sediments. These additional heat exchangers can be with a parallel reserve connection ensuring the operation of one exchanger while the other is under repair (cleaning).

An object of the present invention is the use of a water heat accumulator provided in the aquifer for the compressor intersection cooling accumulation in GAES. If the GAES consists of several energetic blocks, underground water heat accumulator(-s) formed in the aquifer(-s) may be common for these energetic blocks.

If the compressor internal cooling and the turbine internal heating systems are used, then the above mentioned compressor and the turbine intersection cooling and heating are in force.

To raise the CE of the GAES, the compressor and the turbine blocks 2 and 17 are equipped with an accumulation and regeneration system of the bearing and gearing friction energy losses. The purpose of this system is to accumulate and regenerate into electric energy by means of the turbine block 17 the losses of energy which are equivalent to the amount of heat produced by mechanical friction of the bearings and gearings of the electric motor 3, compressors 4 and 6, turbines 18 and 19, the turbogenerator 21 and multiplicators 5 and 20. Simultaneously, by means of this system the losses of thermal energy can also be partly accumulated and regenerated which arise due to the heat outflow through the rotor ends of compressors 4 and 6, and turbines 18 and 19. The above losses of friction energy are transferred by means of heated oil from the electric motor 3, compressors 4 and 6, turbines 18 and 19 and the turbogenerator 21 to the oil cooler 23. In the same manner the friction energy losses are transferred from multiplicators 5 and 20 to the oil cooler 24 equipped with a heat exchanging oil-heat carrier contour. Water and other liquids of corresponding viscosity and boiling temperature can be used as liquid heat carriers. FIG. 1 does not depict complete oiling systems of compressors and turbine blocks 2 and 17, shows only the coolers 23 and 24 of these systems.

The said amount of thermal energy of the hot heat carrier liquid, which is equivalent to the losses of mechanical friction energy, is delivered by means of the circulation pump 25 to and accumulated in the heat accumulator 26, which is a container of appropriate volume and a thermal insulation casing 7. The heat accumulator 26 is operating in a sliding temperature mode.

By means of the circulation pump 27 the thermal energy stored in the heat accumulator 26 during the turbine cycle is transferred to the internal heating system 28 of the low-pressure air turbine 19 used to heat the respective stages of the turbine 19, and, through these stages,—the flowing WMA, thus converting the thermal energy of the heat carrier liquid in the turbine 19 into an equivalent amount of mechanical energy, and, vice versa, by means of the turbogenerator 21,—back to the electric energy.

It should be noted that the losses of the mechanical friction energy in the turbine block 17 are not accumulated but they only flow through the heat accumulator 26. This circumstance decreases the volume of the heat accumulator 26 by half since only the mechanical friction heat energy of the compressor block 2 is accumulated.

The internal heating system 28 in the turbine 19 is created in such a way that it ensures circulation of the heat carrier liquid in the stator casings of the respective stages of the turbine and jet apparatus. If the internal heating system 28, which is provided in the air turbine 19, is not able to “acquire” all the amount of the accumulated heat, then it is purposeful to divide the turbine 19 between the corresponding stages into two separate bodies and to heat the WMA in the heat exchanger liquid placed between these bodies.

In order to implement the described system for the accumulation and regeneration of the friction energy losses, high-quality, heat-resistant synthetic turbine and gear reducer oils should be used in the lubrication systems of the compressor and turbine blocks 2 and 17.

The heat accumulator 26 may be formed in the aquifer 15 and be common for several energetic blocks.

The use of the accumulation and regeneration system of the mechanical friction energy losses allows raising the CE of the GAES by approximately 3.5%, and the use of this system in the GAES is an object of the present invention.

The conventional designs of pressure ducts 13 are not fit for the transfer of air heated to 650-700° C. to the UHA 14 for the following reasons:
due to the great difference in temperatures between the pressure duct 13 (650-700° C.) and the surrounding rock 29 (15-20° C.), and the cyclic variations in temperature (at least twice in 24 hours) the cement block 30 which ensures the fastening of the pressure duct 13 in the surrounding rock 29 and the impermeability of the fastening would be destroyed.
due to the great difference in temperatures there would be considerable losses of heat, which would affect correspondingly the CE of the GAES.

In order to prevent these shortcomings of the conventional pressure ducts, a design of the pressure duct 13 is offered (FIG. 2) which is an object of the present invention. The pressure duct 13 (FIG. 2) consists of the casing tube 31 cemented by means of the cement block 30 into the surrounding rock 29. The casing tube 31 has a blower tube 32 in it through which the WMA is supplied to (discharged from) the UHA 14. The pressure duct 13 offered (FIG. 2) differs from the known ones by the features that it is formed as a thermos ensuring vacuum in the space between the casing tube 31 and the blower tube 32; that the inner surfaces of the casing tube 31 and the outer surfaces of the blower tube 32 are provided with a coating of the quality that satisfies the requirements of a thermos; that a temperature compensator 33 is provided between the casing tube 31 and the blower tube 32. The aim of the temperature compensator 33 is to compensate the difference in axial thermal expansion between the casing tube 31 and the blower tube 32. Vacuum in the space between the casing tube 31 and the blower tube 32 is ensured by means of the vacuum pump 34.

One of the possible embodiments of the inlet of the pressure duct 13 is shown in reference I (FIG. 2). Casing tube 31 and the input end of blower tube 32 are welded together and hermetically fixed. The vertical load (weight) of blower tube 32 is transferred to casing tube 31, for example, by means of a support platform 35, 35′ but impermeability is ensured, for example, by means of ring(s) 36.

Support platform 5 is welded to casing tube 31 but support platform 35′ is welded to blower tube 32. Other embodiments are possible as well.

The embodiment of the pressure duct 13 as a thermos prevents almost all the losses in the pressure duct 13. By maintaining the temperature of the casing tube 31 equal to the temperature of the surrounding rock 29, stable and safe fastening of the pressure duct 13 in the surrounding rock 29 is ensured, as well as the impermeability of the cemented spot.

On condition that the UHA 14 is created in sufficiently monolithic and thick collector aquifers 15 with an adequate degree of rock cementation (well-cemented sandstone, limestone, dolomite, etc.), the pressure duct may have the form of a shaft with the central thermos-type pressure duct and horizontal channels 37 formed in the UHA 14 (FIG. 3). Such a shaft embodiment of the pressure duct (FIG. 3) in the GAES is another object of the present invention. The pressure duct 13 (FIG. 3) consists of a casing tube 31 having a large diameter (3-5 m) and a blower tube 32 with a corresponding diameter. By a standard technology and with the help of the cement block 30 the pressure duct 13 is cemented separately into the surrounding rock 29, after that a working zone 38 is created and adequately secured in the collector aquifer 15 from which, by means of a hydraulically-driven robot or another mining method horizontal channels 37 are formed. The diameter and the length of the channels depend on the technical feasibility of the method applied; each channel (37) may further branch off, for example, as ψ.

The pressure duct 13 depicted in FIG. 2 is considered as a point type pressure duct since the volume of the outlet contact surface, in contrast to the volume of the UHA 14, is incomparably small.

The shaft pressure duct depicted in FIG. 3 is considered as a volume type pressure duct since the volume of the outlet channels 37 is comparable with the volume of the UHA 14.

The choice of the pressure duct is determined by the geological structure of the aquifer 15. The point type pressure duct 13 (FIG. 2) is used in cases when the collector stratum 15 is formed from loose sedimentary rock with high porosity and permeability, such as sand, gravel, sand and gravel mixture, loose sandstone, etc.

The shaft pressure duct (FIG. 3), due to its incomparably greater contact surface, is preferred in collector aquifer 15 with a low degree of porosity and permeability, such as well-cemented sandstone, limestone, dolomite, etc. in which by the mining methods horizontal channels 37 can be created. On the foundation of such collector aquifer 15 the GAES can be constructed only using a shaft pressure duct (FIG. 3).

If the point type pressure ducts 13 (FIG. 2) are used, then the GAES project can be really implemented on condition that the number of the operating pressure ducts does not greater than 30-40. The underground inlet structures of the point type pressure ducts commonly used in the underground gas storages (further UGS) do not meet these requirements because of their low permeability. The inlet throughput of the low-pressure duct in the known UGS structures is related to the small contact surface of the pressure duct inlet in the rock and the possible rock displacement due to the fall of the high pressure in the pressure duct inlet during the gas consumption from the storage. In order to prevent the design defects of the conventional point type pressure duct inlets (low permeability, rock displacement), an inlet structure of the point type pressure duct 13 as well as a method of its embodiment (FIG. 4), are offered, which is an object of the present invention.

The offered inlet structure of the point type pressure duct is formed by the following method (FIG. 4). Into a cemented and vacuumed blower tube 32 of the thermos point type pressure duct 13 air is delivered from the mobile compressor 40 and the air heating unit 41, this air having the following parameters:
the maximum allowable air pressure at the inlet end in the collector aquifer 15 depending on the summary pressure of the upper rock;
the maximum allowable air temperature depending on the structure of the pressure duct 13, the rock melting temperature of the collector aquifer 15 and the boiling temperature of the applied rock hardening liquid.

Liquids (at the given temperature) are used as rock hardeners that harden, or burn out, in hot air at a 700° C. temperature and, by hardening (burning out) ensure a good cementation (adhesion) degree of the sand and gravel grains which, after hardening, do not dissolve in water. Very many organic and inorganic substances meet these requirements; of course, the rock hardener should be widely available and cheap. As one of such liquids used for rock hardening could be waste oil.

The rock hardener is heated in the autoclave 42 to the above mentioned temperature and is under pressure which exceeds the air pressure of the compressor 40 in the blower tube 32, the valve 43 being shut.

From the collector aquifer 15 the hot air flows through the lateral apertures of the inlet end of the blower tube 32 and its open end. By checking the amount of the air pumped into the collector aquifer 15 the water in the collector aquifer 15 is pushed back to the air-water front state 44; the rock temperature isotherm with a temperature a little lower than the temperature of the pumped air assumes state T₁. In this state a certain amount of pressurised heated rock hardening liquid is introduced rapidly into the blower tube 32 from the autoclave 42 by opening the valve 43; this liquid is pressed out of the blower tube 32 into the heated collector aquifer 15.

When pumping of the hot air is continued, a state is achieved in which the air hydraulic resistance in the collector aquifer 15 will be approximately equal to the air hydraulic resistance of the collector aquifer 15 before the introduction of the rock hardener. In this situation the rock hardener will occupy a zone in the collector aquifer 15 which will be limited by the contour 45. Continuing the pumping of air, it is heated by means of the air heating unit 41 to 700° C., and the hardening or burning out (in the case of oil) of the rock hardener takes place. If a sufficient rock cementation degree is not attained in one such cycle, then these cycles are repeated. The number of the necessary cycles is determined by test-bench experiments.

If the rock hardener hardens in a zone limited by the contour 45, a well cemented porous collector aquifer 15 zone is produced around the inlet of the pressure duct 13 with high air permeability. After the hardener has become hard, pressure is slowly reduced in the blower tube 32, and it is flooded with the water of the collector aquifer 15.

The inlet air hydraulic resistance of the blower tube 32 depends on the contact surface of the pressure duct inlet and the rock; further from the inlet the total air hydraulic resistance falls in inverse proportionality to the square of distance. In order to increase the contact surface of the pressure duct inlet—an WMA inlet space is formed in the rock by common mining technologies (by means of an expanding chisel head or by washing with a high-pressure jet of water with the help of the hydromonitor), this space being limited by the contour 46. Such a point-type inlet end of the pressure duct 13 in the collector aquifer 15 has a considerably larger contact surface of the pressure tube inlet with the rock, which increases correspondingly the throughput of the pressure duct inlet. At the same time the end of the pressure tube 13 inlet of such a form ensures high air filtration in the well-cemented porous layer of the rock during the turbine cycle.

The operation of the said GAES is described on the basis of the previously chosen example when the rated power of the GAES is 300 MW. As a WMA unit of measurement we accept 1 kg mass of air with the following initial, i.e. atmosphere parameters, besides the hydraulic resistance of the air filter 8 is not taken into consideration:
temperature Tₐ=276 K;
pressure pₐ=0,1 MPa;
volume of 1 kg mass of air Vₐ=0,7921 m³/kg;
enthalpy of 1 kg mass of air hₐ=276 kJ/kg;
relative mean moisture of air (φₐ=95%.

The atmosphere air temperature and relative mean moistures are assumed as the average indices of a night in the year in Northern Europe because the compressor block 2 basically works under night conditions.

In the aspect of thermodynamic processes, the GAES is an intensive thermodynamic system, i.e. its thermodynamic properties are not dependent on the mass of the system. This assumption enables us to regard the GAES processes in operation with a 1 kg mass.

The GAES operation (FIG. 5) consists of three main cycles:
the energy conversion compressor cycle Cₖ;
the storage cycle of the accumulated energy in the UHA 14—Cₐ;
the energy transformation turbine cycle—Cₜ.

As auxiliary cycles are considered the preparatory cycles Cₖₛ and Cₜₛ of the compressors 4 and 6, and the gas turbines 18 and 19.

Besides mobility, as one of the main indices of the GAES operation is its CE η_{GAES}.

$${η}_{GAES} = \frac{{E}_{output}}{{E}_{input}}$$

Where Eₒᵤₜₚᵤₜ is the sum of the energy released by the GAES, at the output of the transformer 1 in a definite lasting period (a month, a year), Eᵢₙₚᵤₜ is the sum of the energy consumed in the same period on condition that the UHA 14 energetic state (p₁₄, T₁₄) is the same at the beginning and at the end of the reference period.

The CE of the GAES consists of four different factors:
η_{GAES}=η_{nck}·η_{ca}·η_{ct}·η_{nz} (1)
where η_{ck}—the CE of the energy conversion compressor cycle Cₖ;
η_{ca}—the CE of the storage cycle of the accumulated energy in the UHA 14 Cₐ;
η_{ct}—the CE of the energy conversion turbine cycle Cₜ;
η_{nz}—the CE of the untallied energy losses.

FIG. 5 shows variations in the energy amount E during the cycles Cₖ, Cₐ, Cₜ of the UHA 14 in the operating mode of the GAES as shown in FIG. 6. Such a schedule of the GAES operating mode would correspond to the variations in a very simplified power conditions in a conditional energetic system if cycle Cₖ proceeds during the night minimum consumption hours from 11 p.m. till 6.30 a.m.; cycle Cₜ takes place during the morning and evening maximum consumption hours from 7 a.m. till 10.00 and from 6 p.m. till 11 p.m.; but the basic cycle Cₐ takes place during the day from 10 a.m. till 6 p.m. If the load of cycle Cₜ by power is assumed as 90%, then a 2.160 GW·h amount of electric energy is transmitted to the external electroenergetic system during cycle Cₜ. When the CE of the GAES is η_{GAES}=90.963% (see page 19), 2.375 GW·h of electric energy are consumed from the external electroenergetic system during cycle Cₖ; when the CE of cycle Cₖ η_{ck}=98.493% (see page 12), 2.339 GW·h of energy are accumulated in the UHA 14 during cycle Cₖ. By concept the energy amount E accumulated during cycle Cₖ (FIG. 5) we understand variations in the amount of active energy in the UHA 14:
Eₖ=E₃−E₁

The amount of energy E₁, which we will call buffer energy practically cannot be applied, and its value depends on the specific circumstances of the UHA 14 operation. In terms of money the amount of buffer energy E₁ can be attributed to the capital investments of the GAES construction.

If the GAES is regarded as a joint thermodynamic system, this system operates in the mode of an adiabatic process, and all the GAES elements should be adiabatically insulated. This adiabatic insulation is ensures by the heat insulation casings 7 of the GAES elements 4, 6, 10,16, 18, 19, the thermos-like embodiment of the pressure ducts 13, and the specific conditions of the UHA 14 operation. The condition of the adiabatic process is valid if the friction heat transfer into the internal heating system 28 of the turbine 19 is ignored.

In a real embodiment the above statement will not ensure complete adiabatic insulation of the thermodynamic system. A criterion of sufficient thermoinsulation quality (the choice of materials, thickness of thermoinsulation) is technical and economical calculations considering the interest rate of the bank credit and the high price of electric energy in the maximum consumption hours.

The operation of compressors 4 and 6 is discussed under condition that the WMA is a real two-atom gas, the mean values of its adiabatic indices K individually for each compressor being determined by tables of the air thermodynamic properties within the temperature range of each compressor.

Under the impact of internal friction and other factors the polytrophic index n of turbocompressors operating in the adiabatic mode is greater than the adiabatic index k.

Compressor 4 is chosen as an axial 9-stage turbocompressor with the mean compression index under pressure ε₄=1.26. The output pressure of the compressor 4:
p_{b}=pₐ·ε₄⁹ p_{b}=0.80045 MPa

The air compression index n₄ of the polytrophic process is determined by the approximation method from the expression

$$\frac{{n}_{4}}{{n}_{4} - 1} = \frac{{k}_{average}}{{k}_{average} - 1} \cdot {η}_{4 pol}$$

on condition that k_{average}=1.3925 and the CE of the polytrophic action axial turbocompressor ηₚₒₗ=0.9
n₄=1.456

Under these conditions the temperature after compression

$${T}_{b} = {T}_{a} ( \frac{{p}_{b}}{{p}_{a}} ) \frac{{n}_{4} - 1}{{n}_{4}}$$

$${T}_{b} = 276 ( \frac{0.80045}{0.1} ) \frac{1.456 - 1}{1.456}$$

$${T}_{b} = 529 K ( 256 ° C . )$$

If the centrifugal turbocompressor 6 is in a single-body embodiment with one two-way working wheel and the compression index at pressure ε₆=4.5, then
p_{c}=3.602 MPa

The air compression temperature T_{c} of the compressor 6 is found as for the compressor 4; if the CE of the polytrophic action of the centrifugal turbocompressor ηₚₒₗ=0.85 and n₆=1.461, then

T_{c}=850 K (577° C.)

The work transmitted to the compressors 4 and 6 from the electric motor 3, if losses are not taken into consideration, is consumed for raising the WMA enthalpy. The WMA enthalpy increase Δh_{c-a} is the measure of the transmitted work.

The GAES works in a sliding-pressure and temperature mode. The working interval of the sliding pressure is determined as a result of complicated technical and economical calculations taking into account the peculiarities of the geological composition of the collector aquifer 15, the principles of the UHA 14 structure, the type and number of the pressure ducts 13, etc.

In the case of our example it is conditionally assumed that the sliding-pressure mode of the GAES constitutes 10% of the maximum working pressure of the compressor 6 (3.602 MPa). Under this condition the sliding-pressure working interval of the GAES varies from 3.242 to 3.602 MPa. The mean pressure p_{c}=3.422 MPa is assumed as a rated working pressure at which the GAES calculations are made.

The air compression temperature is determined as in the previous example at pressure p_{c}=3.422 MPa:
T_{c}=843 K (570° C.)

At pressure p_{c}=3.422 MPa and temperature T_{c}=843 K the WMA enthalpy h_{c}=871 kJ/kg.

The theoretical work L_{c-a} of the compressors 4 and 6 for the compression of 1 kg WMA from the initial parameters (pₐ=0.1 MPa, Tₐ=276 K) to the rated sliding pressure parameters (p_{c}=3.422 MPa,T_{c}=843 K) constitutes:
Lc-a=Δh_{c-a}=871−276=595 kJ/kg

The WMA temperature of the compressors 4 and 6 after compression T_{c} and their theoretical work L_{c-a} depend on the temperature Tₐ of the environment.

The maximum WMA temperature after compression T_{cmax} and the maximum theoretical work L_{(ca)max} of the compressors 4 and 6 are at the maximum night temperature Tₐ=303 K(30° C.) and the maximum working pressure p_{cmax}=3,602 MPa of the compressor 6.
T_{cmax}=933 K (660° C.) L_{(c-a)max}=669 kJ/kg

Correspondingly the minimum temperature T_{cmin} and the minimum work L_{(c-a)min} are at the minimum night temperature Tₐₘᵢₙ=233 K(−40° C.) and the minimum working pressure p_{cmin}=3.242 MPa of the compressor 6.

In our example the maximum working temperature T_{cmax}=933 K (660° C.) of the compressor 6 satisfies the condition that working temperature of the compressor should not exceed 650-700° C. by the modern machine building standards and that it should be lower than the minimum melting temperature (1710° C.) of the porous rock (in our case sand and gravel mixture) of the collector stratum 14.

When the thermoinsulation casings 7 are of high quality, the WMA enthalpy losses of the compressors 4 and 6 comprise basically the air mass leakage through the glands (3 pieces) of the outlet labyrinths of the rotor shaft end of compressors 4 and 6. We assume that at pressure p_{b}=0.80045 MPa, which exists on the end outlet glands, this leakage will not transcend 0.1% of the compressor power. We estimate the heat losses through the thermoinsulation casings 7 and the acoustic sound losses together as 0.05%. The mechanical friction energy losses in the bearings of the compressors 4 and 6 are accumulated and regenerated by means of the regeneration system of the friction energy losses, and they no not influence the EC of the compressors 4 and 6.

Under the above conditions the EC of the compressor 4 and 6 is estimated
η_{4,6}=99.85%

The EC of the energy conversion compressor cycle Cₖ is:
η_{ck}=η₁·η₃·η_{4,6}·η₅·η₈·η₁₀·η₁₃
where: η₁—the EC of the input-output load of the transformer 1 η₁=99.92%
η₃—the EC of the electric motor 3 with a regeneration system of mechanical friction losses
   η₃=98.90%;
η₅—the EC of the multiplicator 5 with a regeneration system of mechanical friction losses
   η₅=99.985%;
η₈—the EC of the air filter 8 at Δp₈=300 Pa η₈=99.953%;
η₁₀—the EC of the main pipelines 10 η₁₀=99.940%;
η₁₃—the EC of the pressure ducts 13 η₁₃=99.940%,
   then η_{ck}=98.493%.

These and following calculations are very approximate; drops of pressure (due to the hydraulic resistance) is not considered, which can be determined only in the case of a particular project.

It is not expedient to distinguish separately the losses UHA 14 during cycle Cₖ, it is purposeful to regard them in a 24-hour period.

During cycle Cₖ the compressor block 2 should pump 1.4152·10⁷ kg of WMA into the UHA 14, the power of the compressor block 2 at the load factor of 95% should be 524.146 kg/sec.

The mechanical friction energy losses in the bearings of turbocompressors constitute 1-2% depending on the turbocompressor power. We assume in our case that these losses constitute 1.05% since heat leakage from the ends of the rotor shaft of the compressor 4 and 6 should be added to these losses as well. The mechanical friction energy losses of the electric motor 3 are assumed as 0.13% of the rated power of the electric motor 3. We assume the mechanical friction energy losses of the multiplicator 5 to be 1% of the transferred power, which constitutes, correspondingly, 0.56% of the rated power. The total amount of thermal energy that is equivalent to the mechanical friction energy losses to be accumulated by the heat accumulator 26 constitutes 1.74% of the rated power of the compressor block 2, or 146.49 GJ of thermal energy should be accumulated during cycle Cₖ.

The launching scheme of the compressor block 2 should be provided with a power regulation system of the electric motor 2 and compressors 4 and 6 which would adjust the power of the compressor block 2 with the power transmission parameters of the external electric energy system. The most optimum power regulation variant of the compressor block 2 is regulation of the inlet air flow of the compressor 4. In order to ensure high mobility of the compressor and the turbine blocks 2 and 17, auxiliary cycles Cₖₛ and Cₜₛ are envisaged to prepare the operation of these blocks in which compressors 4 and 6, and turbines 18 and 19, respectively, are heated with a small WMA flow to bring them to the condition of readiness for work. To prevent a thermal deformation possibility of the rotors of the compressor and the turbine blocks 2 and 17 in a non-operating mode, these blocks, like the steam turbines, should be equipped with a rotor turning mechanism.

Operation of the UHA 14 is treated conditionally in FIG. 7 with a point type thermos pressure duct. In the GAES case the water-air replacement process in the UHA 14 proceeds with essential difference than it takes place in the UGS. In order to perform its functions in a qualitative way, the UHA 14 must be conditioned to pressure, temperature, air and rock moisture.

The UHA 14 conditioned to pressure is viewed in its state in the collector aquifer 15 when the compressed air has pushed water to state hₖ. The cyclic operation of the UHA 14 by pumping a certain amount of the WMA mass mₖ into the UHA 14 during the cycle cₖ and consuming the same amount of the WMA mass mₜ (mₖ=mₜ) during the cycle cₖ causes a two-way movement of air and water in the collector aquifer 15, the hydrogas dynamic processes in the UHA 14 being periodical. The periodicality of these processes arouses periodic oscillations of the air-water front (further—front) 47. By pumping the WMA with a mass mₖ into the UHA 14 during the cycle cₖ the front 47 is pushed by a distance Δh consuming during the cycle cₜ the same amount of the WMA with a mass mₜ from the UHA 14, and the front 47 returns to its previous state mₜ. When the number of cycles is increased per unit of time (conditionally, the frequency) and the former condition is preserved that mₖ=mₜ=const, the amplitude of oscillations of the front 47 Δh will decrease and, at a definite frequency, the state of the front 47 will be practically unchanging, i.e. accumulation of the WMA mass mₖ during the cycle cₖ and the return of the same mass mₜ during the cycle cₖ proceed in a practically unchanging volume of the UHA 14. In this case the WMA accumulation process is isochoric. i.e. V₁₄=const.

In the case of the GAES it is necessary to find such a minimum state of front hₖ when the amplitude of oscillations of the front 47 Δh at a frequency 1 cycle in 24 hours and the accumulated WMA mass mₖ (in our instance, mₖ=1.4152·10⁷ kg) are minimum allowed. Such a UHA 14 state at a definite value hₖ of the front 47 we will call a UHA 14 conditioned state to pressure (volume). The conditioned UHA 14 state to pressure is a multifunctional relation which is determined by:
hₖ=f(mₖ, mₜ, ψ, p₁₄, T₁₄, p₁₅, T₁₅, α, β)
where ψ—the geophysical parameters of the collector aquifer 15, such as porosity, permeability,
piesoconductivity, etc. under the particular working conditions of the UHA 14;

p₁₄—the WMA pressure in the UHA 14;

T₁₄—the temperature of the UHA 14;

p₁₅—the piesometric pressure in the collector aquifer 15;

T₁₅—the temperature in the collector aquifer 15;

α—the index of the geometric shape of the collector aquifer 15;

β—the working mode index of the GAES, e.g. if the GAES is operating in the morning maximum hours.

In all the states of the UHA 14 in which h will be higher than the minimum value of hₖ the UHA 14 will be in a conditioned state to pressure. In the states of the UHA 14 where h will be less than the minimum value of hₖ the UHA 14 will be in an unconditioned state to pressure. In the unconditioned state to pressure, as a result of the movement of the front 47, flooding of the isotherm regions of the UHA 14 would take place, which would cause additional losses of heat and would, correspondingly, affect the EC of the UHA 14.

The thermal energy of the UHA 14 is accumulated in the porous rock of the collector aquifer 15, in our case they are sedimentary gravel and sand grains, but the hot air is accumulated in the space around these grains. If the UHA 14 is conditioned to pressure, and the gain and rock moisture, then the main thermal energy accumulation in the UHA 14 proceeds in a practically dry collector aquifer 15, besides the most part of this rock is in an overheated state, and in such a state the thermoresistance of this rock is very high. Therefore we can regard that the heat transfer in the UHA 14 practically takes place only as a result of the air mass transfer (convection).

The heated air moving through the porous rock of the collector aquifer 15 during cycle cₖ, it contacts the grains of the rock and transfers to them part of its thermal energy, heating them, and cools down simultaneously, decreasing in volume. In such a way a field of variable temperature arises in the UHA 14, its centre being the inlet of the pressure duct 13 and fall on the outer walls of the UHA 14 (the roof, the floor covering and the front 47). The state of the temperature field is depicted in FIG. 7 by means of isotherms. Since the heat outflow is determined by the air mass outflow, the isotherms are extended in the main directions of the air mass movement. In FIG. 7 the isotherms are shown by a solid line at the beginning of cycle cₖ but by a broken line at the end of cycle cₖ.

If a heat transfer occurs from the mass of air to the rock during cycle cₖ, then during cycle cₜ an opposite process takes place—the heat stored in the rock is returned to the mass of air moving from the periphery of the UHA 14 with a lower temperature towards the region of the centre of the pressure duct 13 with higher temperature, and, the air heating, its volume increases.

If the UHA 14 is conditioned to temperature, then, on condition that mₖ=mₜ=const, the isotherms of each individual cycle coincide. The UHA 14 reaches the conditioned state to temperature during several cycles.

From the point of view of thermodynamics and taking into consideration the Joule-Thomson effect which takes place when the WMA expands in porous rocks, the processes within the UHA 14 are isoenthalpic. This means that the WMA enthalpy, which occurs as a result of the movement and accumulation of air in the porous rock of the UHA 14, remains as a full heat function on condition the heat losses are disregarded that arise due to their leakage into the rock surrounding the UHA 14.

The UHA 14 is viewed in a conditioned state to the air and rock moisture when the UHA 14 is conditioned to pressure and temperature; in this state, by the phases of air and water, the UHA 14 can be divided into two parts.

In all the UHA 14 volume enclosed by isotherm tₖᵣ (where tₖᵣ is the water boiling temperature at a particular pressure, in our case, tₖᵣ≈230-235° C.) the water is in a gaseous state of unsaturated vapour. In the volume of isotherm tₖᵣ, which occupies most of the volume of the UHA 14, the water and air system is in a one-phase gaseous state, and in this volume the rock is in an overheated, dry state, the air and the water vapour have completely (by 100%) replaced the collector aquifer 15 water. In the UHA 14 volume conditioned to the air and rock moisture the moisture of air depends on the moisture of the air pumped into it.

After the air has transcended the border of isotherm tₖᵣ in cycle cₖ this air cools down, and beyond the limits of isotherm tₚ where it reaches the saturation degree with water, partial condensation of the water vapour takes place. In the volume between isotherms tₖᵣ and tₚ the UHA 14 is in a two-phase state—the water that has remained in a liquid state in the capillars of the collector aquifer 15, and the air, the water vapour in a gaseous state. Beyond the limits of isotherm tₚ to the very borders of the UHA 14, the liquid phase is supplemented with the water vapour condensate forming in the capillars of the collector aquifer 15 the so-called “water pistons” by which the water vapour condensate is pushed to the periphery of the UHA 14 and evacuated via the drainholes or the front 47 out of the UHA 14. A part of these “water pistons” return to the volume of isotherms tₚ and tₖᵣ during cycle cₜ and evaporates there. Since the amount of the condensate evacuated by such “water pistons” during cycle cₖ will be greater than the amount of the condensate returned during cycle cₜ, the moisture of the air returned during cycle cₜ will be less than the moisture of the air pumped in during cycle cₖ, which is very important to ensure reliable work of the outlet stages of the low-pressure turbine 19 (excludes drop erosion).

Because the rock beyond the limits of isotherm tₖᵣ have a considerably higher temperature than in the case of the UGS (15-20° C.), the hydro-gas-dynamic processes in this part of the UHA 14 proceed much more intensely, with a considerably greater air-water replacement coefficient. This is connected with the fact that the water viscosity beyond the limits of isotherm tₖᵣ is noticeably lower than in the case of the WMA, and correspondingly lesser are also the water surface tension forces in the rock capillars working as a counterforce in the air-water expulsion process. The volume in the UHA 14 between isotherms tₖᵣ and tₚ is practically dry, the remaining water of the collector aquifer 15 not exceeding 34%. The UHA 14 is considered as conditioned to the air and rock moisture since during cycle cₜ the outlet air is a little dryer than the air pumped into the UHA 14 during cycle ck.

Since the processes that take place in the UHA 14 are isoenthalpic, the EC of the UHA 14 is affected by all the factors which are associated with the variability of the enthalpy of the WMA mass accumulated in the UHA 14, and these are, in the UHA 14 instance, the leakage of thermal energy from the UHA 14 to the surrounding rock and the WMA mass leakage through the roof covering of the UHA 14 due to the permeability of its layers (gaps, etc.). The heat leakage from the aquiferous underground collector strata is studied with an aim to use them as water heat accumulators at the working temperatures up to 200° C. In a conditioned state to the temperature in such collector strata results are obtained when the heat losses in 24 hours, as in the GAES instance, do not exceed 0.5% of the amount of heat pumped in during a cycle. Such valuable results are achieved due to the high thermoinsulation of the clay layers insulating the collector stratum. As negative moments in the operation of such heat accumulators should be mentioned:
the fact that the hot water is still in immediate contact with the insulating strata of the aquifer;
the hot water leakage to the surrounding rock due to the migration of water in the collector stratum.

To ensure high CE of the UHA 14 and avoid immediate contact of the hot air with the clay layers insulating the aquifer 15, the inlet of the pressure duct 13 into the collector aquifer 15 is inserted to half-thickness of the collector aquifer 15 on condition that the thickness of the collector aquifer 15 does not exceed 200 m. At such a placement of the inlet of the pressure duct 13 direct contact is avoided of the high-temperature isotherms with the insulating clay layers, which protect simultaneously these layers from the harmful impact of the high temperature (possible hardening, appearance of cracks, etc.). Such a placement of the pressure duct 13 in the collector aquifer 15 is an object of the present invention. At such a placement of the pressure duct 13 the basic amount of the WMA enthalpy is accumulated in the volumes of isotherms tₖᵣ and tₚ where the rock is in an overheated, practically dry state with a very great thermoresistance, and the heat leakage between the isotherms is very small. As a positive moment, if the UHA 14 is conditioned to pressure, should be mentioned the fact that practically no air movement occurs at the insulating walls of the UHA 14 (the roof, the floor covering and the front 47). Oufflow of the heat of the migrating water is excluded as well.

Taking into account the moments mentioned above, one can affirm that the real losses of heat in the UHA 14 will be noticeably lower than 0.5%. As to the possibilities for the air mass leakage due to the permeability of the UHA 14, a normative gas leakage coefficient is envisaged in the case of the UGS, which is 1% of the active amount of gas pumped into the UGS in a year's cycle, and, in the GAES instance, it would constitute 0,003% in a 24-hour cycle. Considering the moments mentioned, we assume that the EC of the UHA 14 in a round-the clock operating cycle will be:
η₁₄=η_{ca}=99.5%

When the porosity of the sedimentary rock (sand, gravel mixture) is 0.4, the WMA mean temperature in the UHA 14 T_{14vid}=550K, the mean pressure in the UHA 14 P_{14vid}≈3,0 MPa, and the average air-water replacement coefficient is 90%, the volume of the UHA 14 in our example will be:
v₁₄≈2.083·10⁷ m³

To ensure high EC of the UHA 14, the collector aquifers 15 should be sufficiently thick. In our example the minimum thickness of the collector aquifer 15 could be about 25-30 m.

If the GAES consists of several individual energetic blocks, these energetic blocks may have a common UHA 14.

After complete conditioning of the UHA 14 to pressure, temperature, air and rock moisture practically dry, well-purified air with minimum possible dropout of sand and gravel grains from the walls of the working space contour 46 of the inlet of the pressure duct 13 is delivered during cycle cₜ along the pressure ducts 13 to the turbine block 17. From the pressure ducts 13 the WMA is transferred along the main air pipeline 10 through the valve 12 (the valve 11 is shut) and the air purification unit 16 to the turbine block 17. As the most rational embodiment of the air purification unit 16 would be the gravitation filter in which the possible dropout of sand and gravel grains could be settled.

The purpose of the turbine block 17 is to convert back the WMA enthalpy energy, as well as the friction heat energy accumulated in the heat accumulator 26 into mechanical energy by means of the air turbines 18 and 19, and, by means of the turbogenerator 21, into electric energy.

Distribution of the WMA pressure between turbines 18 and 19, the number of stages in the axial turbine 19, as well as the embodiment of the turbine jet apparatus should be selected in such a way that the polytrophic index of the WMA expansion process is as high as possible, i.e., that the temperature of the used WMA discharged from the turbine 19 is maximum low, that the difference in the WMA enthalpy between the inlet of the turbine 18 and the outlet of the turbine 19, which is the measure of the mechanical work performed by the turbines 18 and 19 and basically determines the CE of the turbines 18 and 19, is maximum high. The closest analogues of the turbines 18 and 19 are the NPP gas turbine units in which gas (He, CO₂ , etc.) is used as a heat carrier and a working medium. The attained CE of these NPP gas turbines is about 94.5%. Application of the regeneration system of the mechanical friction energy losses enables to raise the CE of the turbines 18 and 19 by approximately 1.05%, and we assume the total EC of the turbines 18 and 19 as η_{118,19}=95,55%.

As in the instance of the compressor cycle cₖ, the CE of the turbine cycle cₜ is:
ηct=η₁·η₁₀·η₁₃·η₁₆·η_{18;19}·η₂₀·η₂₁·η₂₂
where:

η₁—the CE of the load of the input-output transformer 1, η₁=99.92%;

η₁₀—the CE of the main pipelines 10, η₁₀=99.94%;

η₁₃—the CE of the pressure ducts 13, η₁₃=99.94%;

η₁₆—the CE of the air purification unit 16, i.e., the heat losses in the gravitation tower,
η₁₆=99.98%;

η₂₀—the CE of the multiplicator 20 with a regeneration system of mechanical friction losses,
η₂₀=99.985%;

η₂₁—the CE of the turbogenerator 21 with a regeneration system of mechanical friction losses,
η₂₁=98.90%;

η₂₂—the CE of the noise damper 22 at Δp₂₂=300 Pa, η₂₂=99.953%;
then η_{ct}=94.232%.

The main unaccounted energy losses are:
energy consumption of cycles cₖₛ and cₜₛ;
energy consumption for the automated control system, lighting;
heat losses of the heat accumulator 26, the lubrication system of the compressor and the turbine blocks 2 and 17, the CE of the regeneration system of friction losses.

We estimate the total unaccounted energy losses as 1.5% of the rated power of the GAES. In such a case the CE of the unaccounted energy losses constitutes η_{nz}=98,5%.

The CE of the GAES constitutes (Equation 1)
η_{GAES}=90.963%

As said before (p.10), these calculations are very approximate; drops of pressure (due to the hydraulic resistance) is not considered, which can be determined only in the case of a particular project. Considering what was mentioned above, we assume that the actual CE of the GAES will be
η_{GAES act}≈85%

The only real possibility at the present level of development of chemical electric accumulators for the accumulation of a huge amount of electric energy (1000 MW·h, and more) are hydroaccumulating power plants (further—HAPP) the CE of which constitutes 65-75% depending on the difference in the water levels of the upper and the lower reservoirs. The GAES, as an alternative solution for the HAPP have the following advantages:
considerably higher CE, approximately by 15%, which is of principal importance for economics at the great turnover of electric energy;
due to the distribution of adequate collector aquifers the possibilities to create GAES are noticeably greater than those of the HAPP which are confined within relief formations;
the GAES is an ecologically absolutely pure way of accumulating electric energy. Building HAPP reservoirs creates certain problems for the environment;
even on the basis of a small collector aquifer (2-3 billion m³) a GAES can be built with a practically unlimited energy capacity and the total power of the energetic blocks (27 GW and more), which cannot be said about the power of the HAPP limited by particular relief formations.

As an advantage of the HAPP over the GAES one should point out higher mobility of the HAPP, therefore joint operation of both types of energy accumulation is purposeful retaining the HAPP as an option for the removal of the consequences of emergency situations (huge breakdowns, etc.) at the very first moments, further transferring the removal of these consequences to the GAES.

The organic fuel (oil, gas) running out, the only perspective for the development of energetics is the APP and the application of solar energy. If manoeuvring with the power of the APP in order to ensure their high reliability is excluded, then the accumulating power plants become principally necessary for further development of energetics. Likewise, wide application of solar energy is practically indispensable without the development of adequate accumulating capacities. The present GAES can make considerable contribution to the solution of the issue of accumulating capacities.

1-11. (canceled)

12. Air compression heat accumulating power plant with an underground heat accumulator formed in the aquifer (GAES), comprising from principal functional blocks:
Compressor Block (2, FIG. 1) equipped with compressor (4, 6) of the working medium—air (WMA), electric motor (3) and WMA filter (8). Compressor (4, 6) may have a multiple-unit or a multi-sectional embodiment with an external intersectional cooling of WMA by means of the intersectional heat exchanger as well as with internal WMA cooling. By means of Compressor Block (2) the unclaimed electric energy from the external electroenergetic system is converted into the WMA compression heat and WMA pressure potential energies;
It can contain Heat Accumulator designed for the accumulation of the WMA external intersectional or internal cooling heat in case compressor (4, 6) equipped with an external intersectional or internal cooling system when the liquid of the intersectional or internal cooling system of compressor (4, 6) as a heat carrier substance is used in Heat Accumulator is used;
Underground Heat Accumulator in which the WMA compression heat and WMA pressure potential energies coming from the final unit or the final section of compressor (4, 6) are accumulated. The Underground Heat Accumulator is formed in a natural or artificially created reservoir of dense hard rock (whinstone) which is simultaneously a compressed WMA storage. In another embodiment the WMA compression heat is accumulated in the reservoir of the abovementioned hard rock (whinstone) which is filled with a heat accumulating substance (crushed stone, ceramics, and others) when the compressed WMA is stored in a separate underground reservoir which is formed after the aforementioned heat accumulator. Underground Heat Accumulator operates in a sliding pressure and temperature mode or, in a constant pressure mode if Underground Heat Accumulator is equipped with an upper water basin;
Turbine Block (17) equipped with the WMA turbine (18, 19), turbogenerator (21) and noise damper (22). Turbine (18, 19) may be in a multiple-unit or a multi-sectional embodiment with an external intersectional heating of WMA by means of the intersectional heat exchanger, as well as with internal WMA heating when this heat for heating is taken from Heat Accumulator designed for the accumulation of the WMA external intersectional or internal cooling heat in case compressor (4, 6) equipped with an external intersectional or internal cooling system. By means of Turbine Block (17) the WMA compression heat and WMA pressure potential energies from Underground Heat Accumulator, as well as the potential heat energy from Heat Accumulator designed for the accumulation of the WMA external intersectional or internal cooling heat (if it is used) are converted into electric energy which is returned into the external electroenergetic system during the energy gap. In individual cases turbine (18, 19) may be equipped with a combustion chamber;
Electric motor (3) and turbogenerator (21) may have the embodiment of an electric motor-generator which is common for Compressor Block (2) and Turbine Block (17) when clutch attachments are installed between compressor (4, 6) and electric motor-generator, and electric motor-generator and turbine (18, 19);
In another embodiment, the WMA external intersectional cooling heat exchanger(s) or the internal WMA cooling system of compressor (4, 6), as well as the WMA external intersectional heating heat exchanger(s) or the internal WMA heating system of turbine (18, 19) are common. In this case the WMA current is directed by corresponding valves
characterised by the fact that with an aim to increase energy capacity till practically unlimited energy capacity and efficiency coefficient of the GAES, Underground Heat Accumulator (14), which is simultaneously a compressed WMA storage, is formed in a vertically closed, porous aquiferous underground collector stratum (aquifer) (15) into/out of which the WMA is transferred by means of pressure duct(s) (13), when:
The WMA compression heat is accumulated in the grainy mass (sand, gravel, and other) of the porous rock of Underground Heat Accumulator (14) or in the mass (sandstone, limestone, and other) of the porous structure of Underground Heat Accumulator (14), which takes place in the WHA by moving in the porous rock of the Underground Heat Accumulator (14) by way of convection when the WMA is transferred through the porous rock of the Underground Heat Accumulator; The compressed WMA is stored in the space among the grains (sand, gravel, and other) of the porous rock of Underground Heat Accumulator (14) or in the porous structures (sandstone, limestone, and other) of Underground Heat Accumulator (14);
Underground Heat Accumulator (14) is vertically closed from above with an air-roof covering of a clay layer or layers, and with other rocks; from below it is confined with a floor covering (crystalline foundation, and other rock); in individual cases the lower layers of aquifer (15) may be a floor covering; Underground Heat Accumulator (14) being separated from aquifer (15) by the WMA—water front (47, FIG. 7); Underground Heat Accumulator (14) is equipped with pressure duct(s) (13) through which the WMA is transferred into/out of Underground Heat Accumulator (14). The layout of pressure ducts (13) is dependent on the power of the energoblock or the total power of the GAES, as well as the geophysical parameters (thickness, rock porosity, permeability, and others) of Underground Heat Accumulator (14). Besides Underground Heat Accumulator (14) may be equipped with control, observation, pressure-relief drainage and other auxiliary function wells;
If the GAES consists of several individual energoblocks, then Underground Heat Accumulator (14), which is designed according to claim 1, may be common for all the energoblocks.

13. Air compression heat accumulating power plant with an underground heat accumulator formed in the aquifer (GAES) according to claim 12, characterised by the fact that, with an aim to increase the efficiency coefficient and ensure stable operation of the GAES, Underground Heat Accumulator (14) and operating in a sliding pressure and temperature mode may be conditioned (a condition meeting certain work readiness norms within the range of sliding pressure and temperature mode) to the pressure (volume), temperature, moisture of the accumulated WMA and rock of Underground Heat Accumulator (14) ensuring the stability of the said parameters in compliance with certain norms of Underground Heat Accumulator (14) operation if the WMA mass conveyed into Underground Heat Accumulator (14) by compressor (4, 6) in a cycle is equal to the WMA mass consumed by turbine (18, 19) in a cycle delivered from Underground Heat Accumulator (14), then:
In Underground Heat Accumulator (14) in a conditioned state to pressure (volume), the processes of the WMA heat and mass changing take place in a constant volume of Underground Heat Accumulator (14) when the volume occupied by Underground Heat Accumulator (14) is equal to or greater (considerably greater) than the actual volume in which the WMA heat and mass changing process takes place. The WMA—water front (47, FIG. 7) is constant. In this state the WMA heat and mass changing process is isohoric. The conditioned state of Underground Heat Accumulator (14) is achieved by means of the conveyed WMA, pushing the WMA—water front (47) to a certain calculated state;
In Underground Heat Accumulator (14) in a conditioned state to temperature the amount of heat introduced into Underground Heat Accumulator (14) during the cycle by compressor (4, 6) is equal to the amount of heat delivered from Underground Heat Accumulator (14) and consumed by turbine (18, 19). In this state the WMA heat and mass changing process is isoenthapic. The state of Underground Heat Accumulator (14) conditioned to temperature is achieved in a situation when Underground Heat Accumulator (14) is in the conditioned state to pressure (volume), carrying out the heating of the rocks (sand, gravel, sandstone, and other) of Underground Heat Accumulator (14) in this state, which takes place during several cycles with the help of the conveyed WMA until the abovementioned norm is ensured about the equality of the amount of heat of the introduced and the consumed WMA;
In a conditioned state to the moisture of the WMA and Underground Heat Accumulator (14) rocks these parameters are dependent on the moisture of the atmospheric air, and this state of Underground Heat Accumulator (14) is practically achieved by previously described conditioning of Underground Heat Accumulator (14) to temperature.

14. Air compression heat accumulating power plant with an underground heat accumulator formed in the aquifer (GAES) equipped with Heat Accumulator designed for the accumulation of the WMA external intersectional or internal cooling heat in case compressor (4, 6) equipped with an external intersectional or internal cooling system according to claim 12, characterised by the fact that, with an aim to simplify the structure, to raise its reliability and efficiency coefficient, Heat Accumulator of the WMA compressor (4, 6) external intersectional or internal cooling system Heat Accumulator is designed as a water heat accumulator formed in a vertically closed, porous aquiferous underground collector stratum (aquifer) when the WMA external intersectional cooling heat exchanger(s) or the internal WMA cooling system of compressor (4, 6), as well as the WMA external intersectional heating heat exchanger(s) or the internal WMA heating system of turbine (18, 19) are cooled or heated by means water conveyed by a circulation pump from the water underground heat accumulator formed in the aquifer, besides:
In one of the embodiments, the WMA external intersectional cooling heat exchanger(s) or the internal WMA cooling system of compressor (4, 6), as well as the WMA external intersectional heating heat exchanger(s) or the internal WMA heating system of turbine (18, 19) are cooled or heated by means of a heat carrier (distilled water under appropriate pressure, oil, and other) conveyed from the intermediate heat exchanger (the water from the water underground heat accumulator and a heat carrier—distilled water under appropriate pressure, oil, and others);
If the GAES as described in this claim, consists of several individual energoblocks, then the water underground heat accumulator designed according this claim may be common for all the energoblocks.

15. Air compression heat accumulating power plant with an underground heat accumulator formed in the aquifer (GAES) according to claim 12, characterised by the fact that, with an aim to raise the efficiency coefficient of the GAES, Compressor and Turbine Blocks (2 and 17) are provided with an accumulation and regeneration systems of the bearing and gearing friction heat, by means of the heat carrier liquid, the said friction heat from the lubrication systems and accumulating them in the heat accumulator (26), when:
By means of the heat carrier liquid, the corresponding outlet stages of the air turbine (19) are heated during the turbine cycle, the temperature of the WMA in the said outlet stages of the air turbine (19) being lower than the temperature of the heat carrier liquid—or from which the heat exchanger of the heat carrier liquid;
The WMA placed in the tract of the WMA before the corresponding stages of the air turbine (19) is heated;
The heat accumulator (26) is formed as an underground water heat accumulator in a vertically closed, porous aquiferous underground collector stratum(-a) (aquifer);
The underground water heat accumulator, according to this claim, is common for several individual energoblocks of which GAES consists.

16. Air compression heat accumulating power plant with an underground heat accumulator formed in the aquifer (GAES) according to claim 1, characterised by the fact that, with an aim to ensure the transfer of the high-temperature WMA into and out of the Underground Heat Accumulator (14) ensuring minimal WMA heat losses, pressure duct is designed as a thermos-type pressure duct (13), when:
Vacuum is ensured in the space between casing tube (31) of thermos-type pressure duct (13) (FIG. 2) and blower tube (32), for example, by means of vacuum pump (34);
The finishing (coating and quality) of the internal surface of casing tube (31) and the external surface of blower tube (32) satisfies the requirements of a thermos;
Casing tube (31) and the input end of blower tube (32) are welded together and hermetically fixed. The vertical load (weight) of blower tube (32) is transferred to casing tube (31), for example, by means of a support platform (35, 35′) but impermeability is ensured, for example, by means of ring(s) (36);
Temperature compensator (33) is provided between casing tube (31) and the output end of blower tube (32) ensuring compensation of the axial linear thermal expansion difference and the impermeability of the connection.

17. Air compression heat accumulating power plant with an underground heat accumulator formed in the aquifer (GAES) according to claim 12, characterised by the fact that, with an aim to increase the efficiency coefficient GAES when Underground Heat Accumulator (14) is formed in aquifer (15) rock (sand, gravel, poorly cemented sandstone, and other) with a low cementation degree, then expanded inlet space (46, FIG. 2) is formed in thermos-type pressure duct (13) at its inlet end by means of mining technologies, when:
The poorly cemented rock (sand, gravel, poorly cemented sandstone, and other) around the inlet end of Underground Heat Accumulator (14) is additionally cemented by the method described in Description;
The maximal dimensions of expanded inlet space (46) are determined by the available possibilities of mining technologies and the mechanical properties of the additionally cemented rock.

18. Air compression heat accumulating power plant with an underground heat accumulator formed in the aquifer (GAES) according to claim 12, characterised by the fact that, with an aim to increase the efficiency coefficient GAES when Underground Heat Accumulator (14) is formed in aquifer (15) rock (well cemented sandstone, limestone, and other) with a high cementation degree, then the inlet space is formed as a mine with a central expanded inlet space (38, FIG. 3) from which horizontal channels (37) are formed in Underground Heat Accumulator (14) rock by means of the mining technologies, when:
Thermos-type pressure duct (13) of a great diameter is used to ensure the application of a mining technology;
Each horizontal channel (37) may further branch off, for example, as ψ;
Minimal dimensions (diameter, length, branching, and others) of horizontal channels (37), as well as their number, are determined by technical and economical considerations.

19. Air compression heat accumulating power plant with an underground heat accumulator 8. Air compression heat accumulating power plant with an underground heat accumulator formed in the aquifer (GAES) according to claim 12, characterised by the fact that, with an aim to ensure high efficiency coefficient of Underground Heat Accumulator (14), the inlet end of thermos-type pressure duct (13) is inserted to half-thickness of Underground Heat Accumulator (14) on condition that its thickness does not exceed 200 m, formed in the aquifer (GAES) according to claims 1, 4 and 5 or 6, characterised by the fact that, with an aim to ensure high efficiency coefficient of Underground Heat Accumulator (14), the inlet end of thermos-type pressure duct (13) is inserted to half-thickness of Underground Heat Accumulator (14) on condition that its thickness does not exceed 200 m.

20. Underground Heat Accumulator(14), as described in claim 12, which can be also used for other technological needs such as a gas storage working in a cyclic operating mode for gases with high temperature.
